(19) United States
(12) Patent Application Publication
(10) Pub. No.: US 2009/0171936 A1
(43) Pub. Date: Jul. 2, 2009

(54) System, Method, and Computer Program Product for Accelerating Like Conditions

(75) Inventors: Steven A. KIRK, Chelmsford, MA (US); David E. Walrath, Stow, MA (US); Roger D. Macnicol, Hollis, NH (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Sybase, Inc., Dublin, CA (US)

(21) Appl. No.: 11/966,620

(22) Filed: Dec. 28, 2007

(51) Int. Cl. G06F 17/30

(52) U.S. Cl. 707/5; 707/E17.014

(57) ABSTRACT

A system, method, and computer program product are provided for optimizing LIKE-condition based queries on a table in a database system.

### BACKGROUND OF INVENTION

1. Field of the Invention

The present invention relates generally to databases and, more particularly, to query optimization in a database.

2. Description of the Background Art

Databases commonly organize data in the form of tables, each table having a number of rows and columns. Each row in a table generally has a data value associated with each of the columns, this intersection of rows and columns commonly called a cell. A system needing access to data in the database typically issues a request in the form of a query. A query usually involves a request for the data contained in one or more cells of any rows which meet a particular condition. This condition often involves the comparison of the values of cells in a column to some other value to determine whether the row associated with the compared cell meets the condition.

A direct comparison of each cell of interest in a table to a value is often computationally expensive, and database developers have accordingly introduced means by which rows meeting a comparison operation can be more readily determined without the need to traverse every row of a table. A typical optimization involves the use of a tree structure to determine which rows contain a desired value. Each node of the tree represents a different value appearing within a particular column in any row of the table. Each node comprises a bitmap indicating that particular rows corresponding to each bit of the bitmap have the value in the particular column.

This approach is reasonably efficient when an exact value is desired, such as with, for example, a query for all rows in which a particular column has the string value “Sybase”. In this approach, database software would traverse the tree structure to locate the node corresponding to the string “Sybase” and retrieve an associated bitmap. The rows for which the value of the particular column is “Sybase” would be represented by “set” bits in the bitmap (i.e., bits set to either a ‘0’ or a ‘1’ value in order to indicate that a corresponding row meets the condition). As a result, the database software is able to simply retrieve those rows and produce a result set from them.

However, this approach does not provide an optimal solution for more complex operations. For example, it is sometimes necessary to process a query for all rows in which the value of a particular column is “like” a string which contains wildcard characters. In this case, there would be no benefit to the aforementioned approach, as it would require the traversal of each individual string to locate a match for an operand such as “% Sybase %”, where ‘%’ is a wildcard character.

Accordingly, what is desired is a technique for efficiently processing queries that comprise “like” conditions.

### SUMMARY OF INVENTION

Embodiments of the invention include a method for optimizing a LIKE query on a table in a database system. The method includes the steps of receiving the LIKE query, the query requesting a set of result rows wherein values of a column of the result rows matches a search string, traversing a data structure to locate a node representing a token of the search string, accessing a bitmap associated with the node, determining a preliminary set of result rows responsive to the query, the preliminary set of result rows based on the bitmap, and removing result rows from the preliminary set of result rows to generate a final set of result rows based on knowledge of the position of the search string within the value of the column associated with a result row being removed.

Embodiments of the invention additionally include a computer program product comprising a computer usable medium having computer program logic recorded thereon for enabling a processor to optimize a LIKE query on a table in a database system. The computer program logic includes receiving means for enabling a processor to receive the LIKE query, the query requesting a set of result rows wherein values of a column of the result rows matches a search string, traversing means for enabling a processor to traverse a data structure to locate a node representing a token of the search string, accessing means for enabling a processor to access a bitmap associated with the node, determining means for enabling a processor to determine a preliminary set of result rows responsive to the query, the preliminary set of result rows based on the bitmap, and removing means for enabling a processor to remove result rows from the preliminary set of result rows to generate a final set of result rows based on knowledge of the position of the search string within the value of the column associated with a result row being removed.

Embodiments of the invention further include a system capable of optimizing a range-based query on a table in a database system. The system includes a first module to receive the LIKE query, the query requesting a set of result rows wherein values of a column of the result rows matches a search string, a second module to traverse a data structure to locate a node representing a token of the search string, a third module to access a bitmap associated with the node, a fourth module to determine a preliminary set of result rows responsive to the query, the preliminary set of result rows based on the bitmap, and a fifth module to remove result rows from the preliminary set of result rows to generate a final set of result rows based on knowledge of the position of the search string within the value of the column associated with a result row being removed.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 illustrates a database network in which the present invention is implemented, in accordance with an embodiment of the present invention.

FIG. 2 illustrates a data structure used to provide an alternate means of indexing data in a database table, in accordance with an embodiment of the present invention.

FIG. 3 is a flowchart illustrating steps by which a database server is operable to handle a “like” operation with a search string nested between two wildcards, in accordance with an embodiment of the present invention.

FIG. 4 is a flowchart illustrating steps by which a database server is operable to handle a “like” operation with a search string located at the beginning or end of a searched field with a wildcard set of characters on the opposite end of the string, in accordance with an embodiment of the present invention.

FIG. 5 is a flowchart illustrating steps by which a database server is operable to handle a “like” operation with an exact search string, in accordance with an embodiment of the present invention.

FIG. 6 is a flowchart illustrating steps by which a database server is operable to handle a “like” operation with a set of substrings located between a wildcard set of characters and separated by another wildcard set of characters, in accordance with an embodiment of the present invention.

FIG. 7 is a flowchart illustrating steps by which a database server is operable to optimize the usage of the aforementioned “like” operations to prefetch result rows, in accordance with an embodiment of the present invention.

FIG. 8 is a flowchart illustrating steps by which a database server is operable to handle a “like” operation with a set of substrings located between a wildcard set of characters and separated by a single wildcard character, in accordance with an embodiment of the present invention.

FIG. 9 depicts an example computer system in which embodiments of the present invention may be implemented.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### I. Introduction

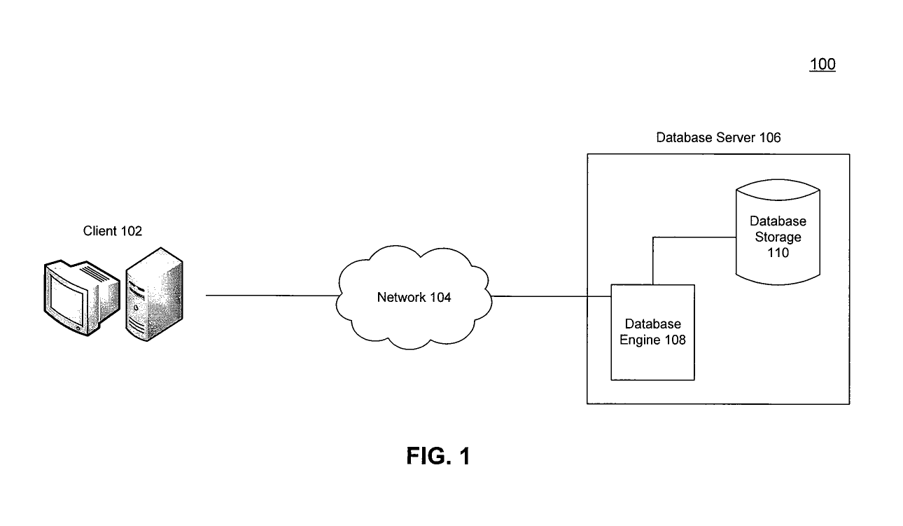

FIG. 1 depicts a database network 100 in which the present invention is implemented, in accordance with an embodiment of the present invention. The database network 100 includes a client system 102, a network 104, and a database server 106. The database server 106 includes a database engine 108 and database storage 110.

Client system 102 is operable to send a request for data, commonly in the form of a database query, to database server 106 over network 104. Database server 106 replies to the request by sending a set of results, commonly in the form of result rows from a database table, to client system 102 over network 104. One skilled in the relevant arts will appreciate that any data format operable to convey a request for data and a reply to the request may be used. In accordance with an embodiment of the present invention, the requests and replies are consistent with the conventions used in the Structured Query Language (“SQL”), although this example is provided solely for purposes of illustration and not limitation.

Network 104 is optionally either a public or private communications network. In accordance with an embodiment of the present invention, network 104 is the Internet. In accordance with an additional embodiment of the present invention, network 104 is a private intranet, such as a corporate network.

When a request for data, such as a query, is received by database server 106, it is handled by database engine 108, in accordance with an embodiment of the present invention. Database engine 108 is operable to determine the data requested by the query, obtain the data, and provide a reply to the query. One skilled in the relevant arts will appreciate that while database engine 108 is illustrated as a single module in database network 100, database engine 108 may be implemented in a number of ways in order to accomplish the same function, including separating each of the aforementioned operations performed by database engine 108 into individual modules. Accordingly, the illustration of modules in database server 106 is not a limitation on the implementation of database server 106.

Database engine 108 is operable to obtain the data in response to the query from database storage 110, in accordance with an embodiment of the present invention. Database storage 110 stores values of a database in a data structure. In accordance with an embodiment of the present invention, database values are stored in a table data structure, the table having data rows and columns. At the intersection of each row and column is a data cell, the data cell having access to a data value corresponding to the associated row and column. Each column, in accordance with an embodiment of the present invention, has an associated data type, such as “string” or “integer,” which is used by database engine 108 and client system 102 to interpret data contained in a data cell corresponding to the column. In accordance with an embodiment of the present invention, the database comprises multiple tables.

Additionally, database storage 110 comprises alternate means of indexing data stored in a table of a database, in accordance with an embodiment of the present invention. Database engine 108 is operable to analyze a query to determine whether an available alternate means is useful to optimally access the data stored in a table, then utilizes this alternate means to obtain data from the table, in accordance with an embodiment of the present invention. The present invention is usable as such an alternate means of indexing data stored in a database table, although one skilled in the relevant arts will appreciate that alternate means of invoking the algorithms disclosed herein in order to access data within a database are within the scope of the present invention.

### II. Bitmap Tree

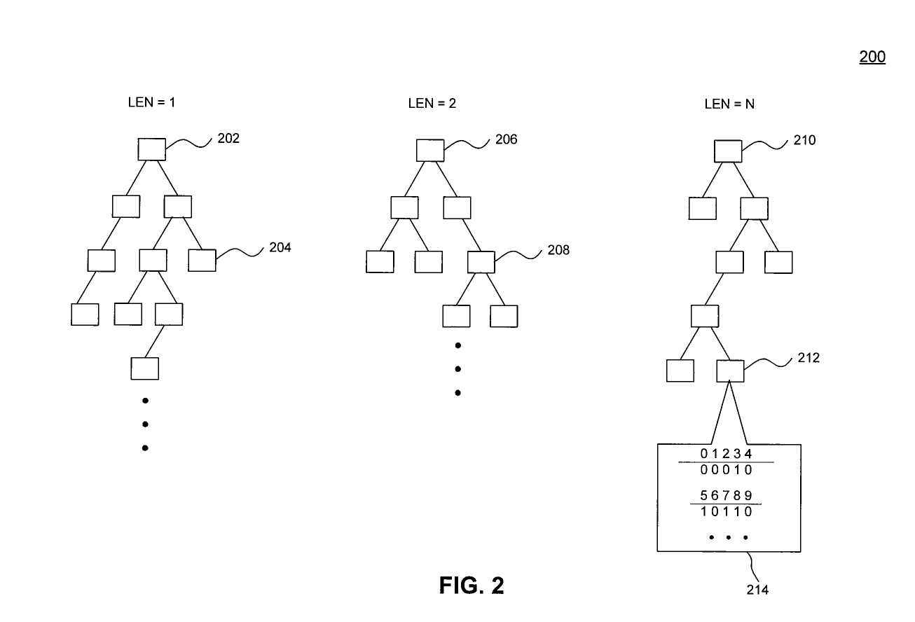

FIG. 2 depicts a data structure 200 used to provide an alternate means of indexing data in a database table, in accordance with an embodiment of the present invention. Data structure 200 is depicted as a binary search tree (“BST”), but one skilled in the relevant arts will appreciate that the present invention is optionally implemented with the use of other types of tree structures, as well as other types of non-tree data structures.

Data structure 200 includes a number of individual trees, each originating from a separate root node, such as root nodes 202, 206, and 210. Each tree also has leaf nodes, such as nodes 204, 208, and 212. Data structure 200 is traversed by database engine 108, in accordance with an embodiment of the present invention, in order to locate a node corresponding to a data value in a query. Each node identifies rows in a database table for which a particular column of that row (i.e., a cell) contains the requested value. For example, if database engine 108 receives a query for all of the data in each row where the value of “column A” is LIKE “% Sybase %” in a table, database engine 108 is operable to retrieve a data structure, such as data structure 200, corresponding to “column A”, and is then further operable to traverse the data structure in order to locate a node which contains the string “Sybase” somewhere in that column, in accordance with an embodiment of the present invention. The located node includes information identifying the specific rows in the table where the value of “column A” is LIKE “% Sybase %”, thereby eliminating the need for database engine 108 to traverse each row of the table in order to compare the entries of “column A”.

In accordance with an embodiment of the present invention, each node comprises a bitmap 214. The bitmap 214, an example of which is shown in FIG. 2, is an array of bits wherein each bit of the bitmap is associated with a row of a table. The individual bits of the bitmap are toggled between ‘0’ and ‘1’ to indicate whether or not a particular row meets the condition associated with the node in which bitmap 214 is located, in accordance with an embodiment of the present invention. For the purposes of example, a bit having a value of ‘0’ is used to indicate that the node condition is not met for the associated row, and a bit having a value of ‘1’ is used to indicate that the node condition is met for the associated row, but one skilled in the relevant arts will appreciate that the alternate condition may be used.

Each individual tree structure in the above example is generated by choosing a range of string lengths, such as 1 through 8, and generating nodes in the tree corresponding to each possible combination of strings of length 1 through 8 which occur in a particular data column associated with data structure 200. For example, root node 210 is the root of a tree where each node is associated with a string of length N. In the case where N is 8, a node, such as leaf node 212, is generated for each 8-character set occurring in every cell of the data column associated with data structure 200. Accordingly, in the case of two rows (and therefore two such cells in the associated column), where the first cell contains the text “the quick brown fox” and the second cell contains the text “jumped over the lazy dog”, a node would be associated with each of the following strings:
“the quic”; “he quick”; “e quick”; “quick b”; “quick br”; “uick bro”; “ick brow”; “ck brown”; “k brown”; “brown f”; “brown fo”; “rown fox”; “jumped o”; “umped ov”; mped ove”; “ped over”; “ed over”; “d over t”; “over th”; “over the”; “ver the”; “er the l”; “r the la”; “the laz”; “the lazy”; “he lazy”; “e lazy d”; “lazy do”; and “lazy dog”.

As previously mentioned, each node contains a bitmap 214. In this example, the bitmap would comprise two bits, one for each row in the instant database table. The first 12 substrings above, each associated with the first string (i.e., “the quick brown fox”) would each have a bitmap of ‘10’ (where a ‘1’ indicates association with a row) indicating that the substring can be found in the first row, but not in the second, in accordance with an embodiment of the present invention.

Returning to the previous example, if node 212 is associated with the condition whereby “column A” contains the string “Sybase” (either as the entire string or as a component thereof), then bitmap 214 indicates that rows 3, 5, 7, and 8 each contain the string “Sybase” within the cell associated with “column A”, in accordance with an embodiment of the present invention. Accordingly, the query is rapidly resolved by returning only rows 3, 5, 7, and 8 as a result, without the need to retrieve and compare data in the remaining rows.

The present invention proposes an alternative interpretation to the data in bitmap 214, which is discussed further in Section III.

### III. Bitmap Like Conditions

A “LIKE” condition is defined as a condition whereby string pattern values match, either directly or by substitution with wildcard characters. In accordance with an embodiment of the present invention, the wildcard characters ‘%’ and ‘_’ are used, although one skilled in the relevant arts will appreciate that any character combination may be used to represent wildcards. The ‘%’ wildcard is used to represent any possible character or set of characters, including a null set. The ‘_’ wildcard is used to represent any possible single character.

LIKE operations are commonly used to return a set of rows where the values for a particular column of those rows match a string pattern. For example, the following query:
SELECT * FROM Company WHERE Name LIKE ‘Syb %’
   would return any rows in the Company table where the value for the Name column begins with the letters “Syb”, such as where the company name is “Sybase”.

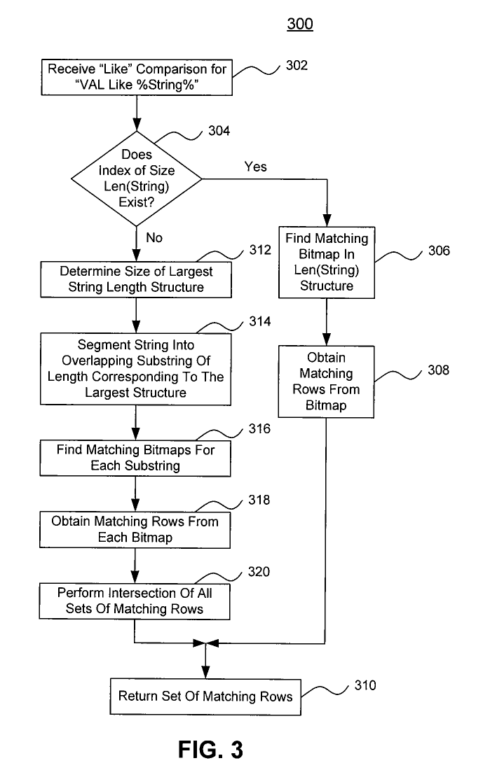

FIG. 3 is a flowchart 300 illustrating steps by which a string comparison of the form “% string %” is resolved using data structure 200 of FIG. 2. At step 302, a LIKE comparison operation is received at a database server, such as database server 106. The LIKE operation has the form “value LIKE ‘% string %’”, such that a string of characters (a “search token”) is nested between ‘%’-type wildcards.

At step 304, the data structure 200 is reviewed in order to determine whether an index exists in which the nodes are associated with substrings of the same length as the search token, in accordance with an embodiment of the present invention. For example, in the case of a LIKE operation consisting of “value LIKE ‘% Sybase %’”, step 304 determines whether a tree with nodes having substrings of length 6 exists (i.e., the 6 characters in the word “Sybase”), in accordance with an embodiment of the present invention.

If such an index exists, the next step 306 is to traverse the index in search of a matching node, the matching node comprising a matching bitmap, in accordance with an embodiment of the present invention. In the above example, for an index of length 6, a node associated with the substring “Sybase” is located. If no matching node is located, then the operation returns zero matching rows. However, if there is a matching node, then the associated bitmap is retrieved. The bitmap is interpreted at step 308 to obtain the set of all matching rows, and the matching rows are returned to a processing module processing the LIKE operation at step 310.

If an index of the necessary size does not exist, the length of the substrings associated with the index having the next-largest length of substrings is determined at step 312, and the search token is segmented into overlapping substrings of length corresponding to the length of the substrings associated with the new index at step 314, in accordance with an embodiment of the present invention. For example, in the case of a LIKE operation on ‘% Sybase %’, where the next-largest index has substring lengths of 5, the search token “Sybase” is segmented into two overlapping substrings of length 5, namely “Sybas” and “ybase”.

At step 316, the new index is traversed in order to locate matching nodes for each search token substring, in accordance with an embodiment of the present invention. If no matching nodes are found for any search token substring, then the operation returns zero matching rows. For each node which matches the search token substrings, the bitmaps associated with the node is retrieved. The bitmaps are interpreted at step 318 to obtain the set of all matching rows for each search token substring, and at 320 the intersection of the sets of matching rows is obtained in order to generate a list of rows which match all conditions. The generated list is then returned at step 310.

By way of example, if “Sybase” is segmented into two search token substrings, “Sybas” and “ybase”, and the bitmap results indicate that “Sybas” is found in rows 4, 7, and 9 of the table, whereas “ybase” is found in rows 7, 13, and 20, then the intersection of those two sets of rows would leave only row 7 as the row which meets both conditions, and therefore contains the complete search string “Sybase”.

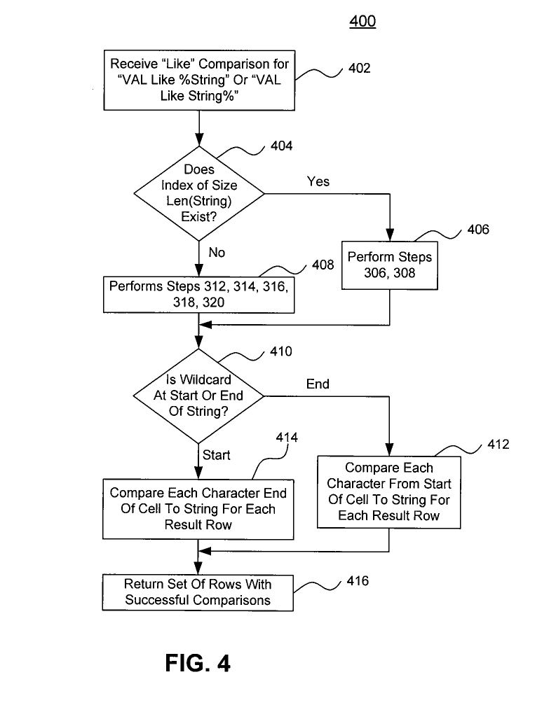

FIG. 4 is a flowchart 400 illustrating steps by which a LIKE comparison with a single wildcard located at one end of a search string is handled, in accordance with an embodiment of the present invention. At step 402, a LIKE comparison operation is received at a database server, such as database server 106. The LIKE operation has the form “value LIKE ‘% string’” or “value LIKE ‘string %’” such that the search token is located at either the beginning or the end of any matching rows.

At step 404, as with step 304 of FIG. 3, the data structure 200 is reviewed in order to determine whether an index exists in which the nodes are associated with substrings of the same length as the search token, in accordance with an embodiment of the present invention. If yes, then at step 406, steps 306 and 308 of FIG. 3 are performed. If not, then at step 408, steps 312, 314, 316, 318, and 320 of FIG. 3 are performed, as previously detailed.

At step 410, the process inquires whether the wildcard is located at the start (e.g., ‘% string’) or at the end (e.g., ‘string %’) of the search string, in accordance with an embodiment of the present invention. If the wildcard is located at the end of the search string, then at step 412 the search string is compared to the column value for each identified matching set of rows, character-by-character, from left-to-right (in character order), in accordance with an embodiment of the present invention. If the wildcard is located at the beginning of the search string, then at step 414 the search string is compared to the column value for each identified matching set of rows, character-by-character, from right-to-left (in reverse character order), in accordance with an embodiment of the present invention. One skilled in the relevant arts will appreciate that if at any point the characters being compared to not match, then the present row under consideration is not a match for the LIKE comparison operation.

As an example, suppose the LIKE operation is searching for the search string “% Sybase”, and has identified rows 3 and 5 of a table as containing the string “Sybase”, by the previously outlined method. Since we know that, in this example, the word Sybase must occur at the end of the column value under consideration, the comparison would proceed as per step 414. The relevant column of row 3 would first be compared from right-to-left, then the same for row 5. Assuming the text of the relevant column for row 3 reads “Sybase, Inc.” and the text of row 5 reads “Copyright 2007, Sybase”, both rows would match the initial comparison tests. However, when comparing row 3 to the search string “% Sybase”, the comparison would first check whether the ‘e’ (rightmost character of the search string) and the ‘.’ (rightmost character of the relevant column) match, and would drop row 3 from consideration upon finding that they do not. When comparing row 5, first the ‘e’, then ‘s’, then ‘a’, and so forth, step 414 would allow for the conclusion that row 5 meets the requirements of the LIKE test.

At step 416, any rows which meet the requirements are then returned to the requesting process.

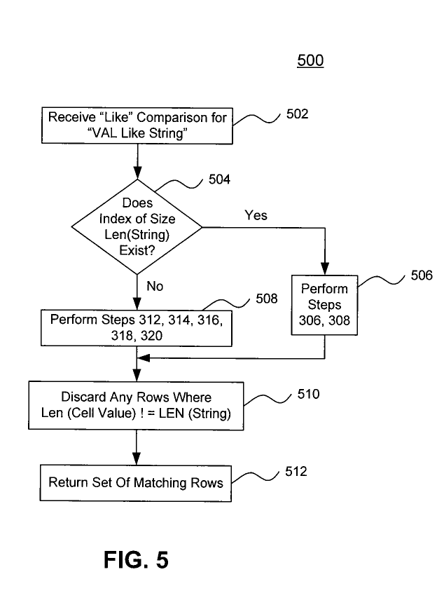

FIG. 5 is a flowchart 500 illustrating steps by which a LIKE comparison with an exact string (no wildcards) is handled, in accordance with an embodiment of the present invention. At step 502, a LIKE comparison operation is received at a database server, such as database server 106. The LIKE operation has the form “value LIKE ‘string’”, such that any matching rows would exactly match the search token.

At step 504, as with step 304 of FIG. 3, the data structure 200 is reviewed in order to determine whether an index exists in which the nodes are associated with substrings of the same length as the search token, in accordance with an embodiment of the present invention. If yes, then at step 506, steps 306 and 308 of FIG. 3 are performed. If not, then at step 508, steps 312, 314, 316, 318, and 320 of FIG. 3 are performed, as previously detailed.

At step 510, the process considers the length of the actual column value for any matching rows thus far, and compares the length to the length of the search string. If the lengths are not the same, then the matching row being considered is discarded. At step 512, any remaining matching rows are returned to the requesting process.

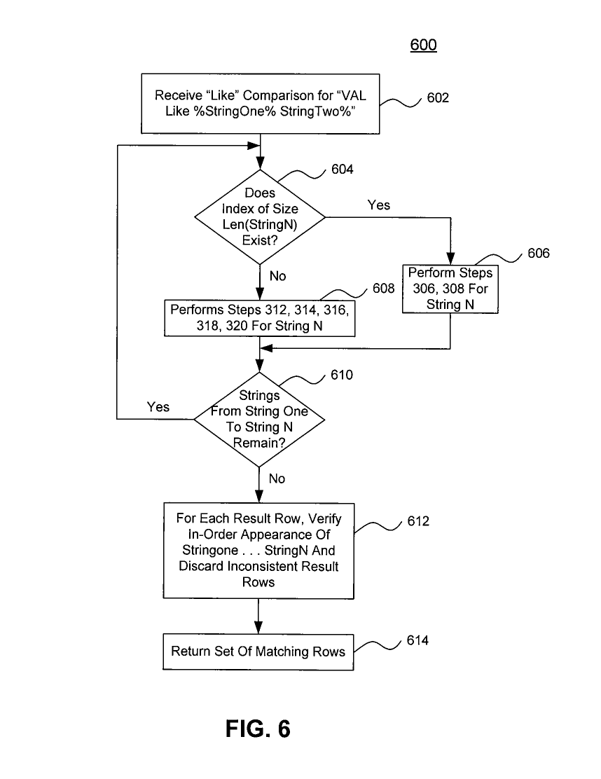

FIG. 6 is a flowchart 600 illustrating steps by which a LIKE comparison with three wildcards is handled, in accordance with an embodiment of the present invention. At step 602, a LIKE comparison operation is received at a database server, such as database server 106. The LIKE operation has the form “value LIKE ‘% stringone % stringtwo %’” there are at least two search tokens (“stringone” and “stringtwo”) located between two wildcards and each separated by a wildcard, in accordance with an embodiment of the present invention.

Beginning with step 604, each search token (generally, “stringN”) is analyzed independently in a similar manner to that detailed in flowchart 300 of FIG. 3, in accordance with an embodiment of the present invention. At step 604, as with step 304 of FIG. 3, the data structure 200 is reviewed in order to determine whether an index exists in which the nodes are associated with substrings of the same length as the search token, in accordance with an embodiment of the present invention. If yes, then at step 606, steps 306 and 308 of FIG. 3 are performed. If not, then at step 608, steps 312, 314, 316, 318, and 320 of FIG. 3 are performed, as previously detailed.

At step 610, the process determines whether any additional strings in the set [stringone . . . stringN] remain, and if so the process repeats for the next string at step 604. If not, then the intersection of all of the result sets for each of the strings is found, and the resulting rows are analyzed at step 612 to determine whether the strings appear in the expected order within the analyzed column, in accordance with an embodiment of the present invention. If the strings do not appear in the correct order, then the result row under consideration is discarded. At step 614, any remaining matching rows are returned to the requesting process.

### IV. Optimization

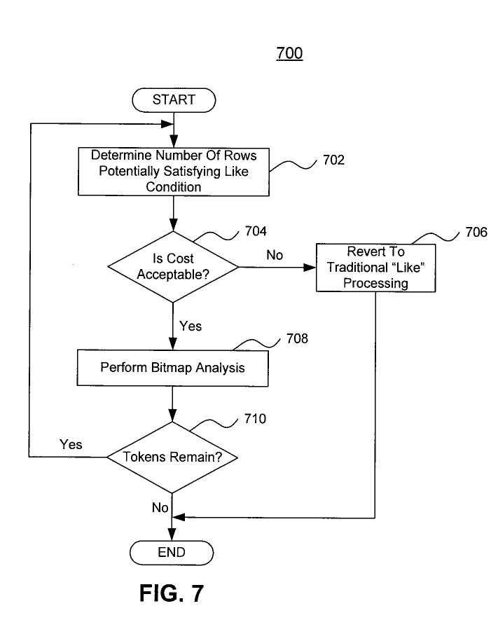

FIG. 7 is a flowchart 700 illustrating steps by which the aforementioned methods are utilized in order to narrow the set of possible result rows, in accordance with an embodiment of the present invention. One skilled in the relevant arts will appreciate that, if a LIKE condition is performed on text such as “% and % zzx %”, it may not be beneficial to perform the aforementioned bitmap analysis methods on the token “and”, based on the common occurrence of the word. However, bitmap analysis on an uncommon string of characters, such as “zzx”, may be beneficial.

At step 702, the number of rows which could potentially satisfy the LIKE condition are considered. At step 704, the cost of performing a bitmap analysis is considered, and if it is not acceptable, then the method reverts to traditional LIKE processing means at step 706. One skilled in the relevant arts will recognize the existence of many well-known means for performing LIKE comparisons, and any may be executed at this point. If the cost is deemed acceptable, then the bitmap analysis is performed at step 708, and at step 710 the process repeats if any tokens remain, provided that the comparison has not reverted to the traditional LIKE processing at step 706.

### V. Advanced Bitmap Like Conditions

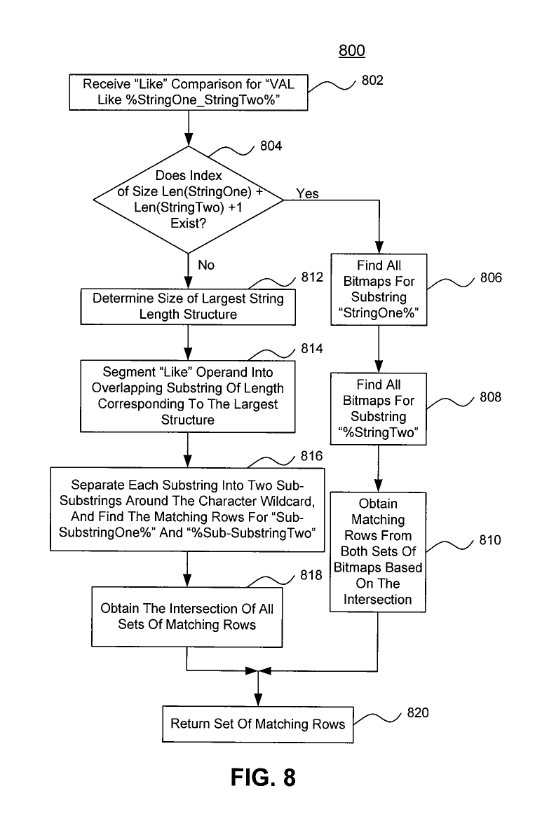

FIG. 8 is a flowchart 800 illustrating steps by which a string comparison of the form “% stringone_stringtwo %” is resolved using data structure 200 of FIG. 2. At step 802, a LIKE comparison operation is received at a database server, such as database server 106. The LIKE operation has the form “value LIKE ‘% stringone_stringtwo %’”, such that two search tokens are nested between ‘%’-type wildcards and separated by a ‘_’-type wildcard.

At step 804, the data structure 200 is reviewed in order to determine whether an index exists in which the nodes are associated with substrings of the same length as the search tokens plus one (to account for the ‘_’-type wildcard), in accordance with an embodiment of the present invention. For example, in the case of a LIKE operation consisting of “value LIKE ‘% Syb_se %’”, step 804 determines whether a tree with nodes having substrings of length 6 exists (i.e., the 3 characters in “Syb”, the 2 characters in “se”, plus the ‘_’-type wildcard), in accordance with an embodiment of the present invention.

If such an index exists, the next step 806 is to traverse the index in search of a matching node for the first search token followed by a wildcard set of characters, the matching node comprising a matching bitmap, in accordance with an embodiment of the present invention. In the above example, for an index of length 6, a node associated with the substring “Syb %” is located. If no matching node is located, then the operation returns zero matching rows. However, if there is a matching node, then the associated bitmap is retrieved. At step 808, the process is repeated for the second search token, prefixed with a wildcard set of characters. In the above example, for the index of length 6, a node associated with the substring “% se” is located. Again, if no matching node is located, then the operation returns zero matching rows. At step 810, the intersection of the result rows from steps 806 and 808 is determined, and returned to the requesting process at step 820.

If an index of the necessary size does not exist at step 804, the length of the substrings associated with the index having the next-largest length of substrings is determined at step 812, and the search string is segmented into overlapping substrings of length corresponding to the length of the substrings associated with the new index at step 814, in accordance with an embodiment of the present invention. For example, in the case of a LIKE operation on ‘% Syb_se %’, where the next-largest index has substring lengths of 5, the search string “Syb_se” is segmented into two overlapping substrings of length 5, namely “Syb_s” and “yb_se”.

At step 816, the segmented substrings are separated around the ‘_’-type wildcard into two sub-substrings each, and matching rows are found for each of the first sub-substring followed by a set of wildcard characters, and the second sub-substring prefixed by a set of wildcard characters, similar to steps 806 and 808, in accordance with an embodiment of the present invention. In the above example, the index of length 5 would be searched for nodes representing the values “Syb %” and “% s”, as well as “yb %” and “% se”. At step 818, the intersection of all such result rows is computed, in accordance with an embodiment of the present invention, in order to produce the final set of matching rows. The results are returned to the requesting process at step 820.

### VI. Example Computer System Implementation

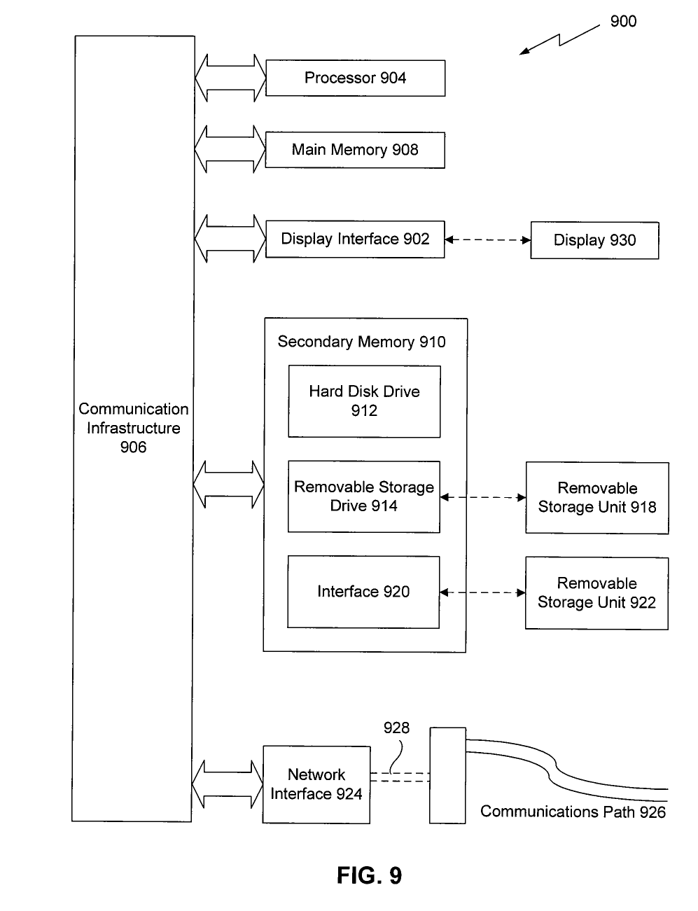

Various aspects of the present invention can be implemented by software, firmware, hardware, or a combination thereof. FIG. 9 illustrates an example computer system 900 in which the present invention, or portions thereof, can be implemented as computer-readable code. For example, the methods illustrated by flowcharts 300 of FIG. 3, 400 of FIG. 4, 500 of FIG. 5, 600 of FIG. 6, 700 of FIG. 7, and 800 of FIG. 8, as well as communication flow diagram 500 of FIG. 5, can be implemented in system 900. Various embodiments of the invention are described in terms of this example computer system 900. After reading this description, it will become apparent to a person skilled in the relevant art how to implement the invention using other computer systems and/or computer architectures.

Computer system 900 includes one or more processors, such as processor 904. Processor 904 can be a special purpose or a general purpose processor. Processor 904 is connected to a communication infrastructure 906 (for example, a bus or network).

Computer system 900 also includes a main memory 908, preferably random access memory (RAM), and may also include a secondary memory 910. Secondary memory 910 may include, for example, a hard disk drive 912, a removable storage drive 914, and/or a memory stick. Removable storage drive 914 may comprise a floppy disk drive, a magnetic tape drive, an optical disk drive, a flash memory, or the like. The removable storage drive 914 reads from and/or writes to a removable storage unit 918 in a well known manner. Removable storage unit 918 may comprise a floppy disk, magnetic tape, optical disk, etc. which is read by and written to by removable storage drive 914. As will be appreciated by persons skilled in the relevant art(s), removable storage unit 918 includes a computer usable storage medium having stored therein computer software and/or data.

In alternative implementations, secondary memory 910 may include other similar means for allowing computer programs or other instructions to be loaded into computer system 900. Such means may include, for example, a removable storage unit 922 and an interface 920. Examples of such means may include a program cartridge and cartridge interface (such as that found in video game devices), a removable memory chip (such as an EPROM, or PROM) and associated socket, and other removable storage units 922 and interfaces 920 which allow software and data to be transferred from the removable storage unit 922 to computer system 900.

Computer system 900 may also include a communications interface 924. Communications interface 924 allows software and data to be transferred between computer system 900 and external devices. Communications interface 924 may include a modem, a network interface (such as an Ethernet card), a communications port, a PCMCIA slot and card, or the like. Software and data transferred via communications interface 924 are in the form of signals which may be electronic, electromagnetic, optical, or other signals capable of being received by communications interface 924. These signals are provided to communications interface 924 via a communications path 926. Communications path 926 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 918, removable storage unit 922, and a hard disk installed in hard disk drive 912. Signals carried over communications path 926 can also embody the logic described herein. Computer program medium and computer usable medium can also refer to memories, such as main memory 908 and secondary memory 910, which can be memory semiconductors (e.g. DRAMs, etc.). These computer program products are means for providing software to computer system 900.

Computer programs (also called computer control logic) are stored in main memory 908 and/or secondary memory 910. Computer programs may also be received via communications interface 924. Such computer programs, when executed, enable computer system 900 to implement the present invention as discussed herein. In particular, the computer programs, when executed, enable processor 904 to implement the processes of the present invention, such as the steps in the methods illustrated by flowcharts 300 of FIG. 3, 400 of FIG. 4, 500 of FIG. 5, 600 of FIG. 6, 700 of FIG. 7, and 800 of FIG. 8, as well as communication flow diagram 500 of FIG. 5, discussed above. Accordingly, such computer programs represent controllers of the computer system 900. Where the invention is implemented using software, the software may be stored in a computer program product and loaded into computer system 900 using removable storage drive 914, interface 920, hard drive 912 or communications interface 924.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### XII. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. A method for optimizing a LIKE query on a table in a database system, comprising:
receiving the LIKE query, the query requesting a set of result rows wherein values of a column of the result rows matches a search string;
traversing a data structure to locate a node representing a token of the search string;
accessing a bitmap associated with the node;
determining a preliminary set of result rows responsive to the query, the preliminary set of result rows based on the bitmap; and
removing result rows from the preliminary set of result rows to generate a final set of result rows based on knowledge of the position of the search string within the value of the column associated with a result row being removed.

2. The method of claim 1, wherein the bitmap represents all rows of the table in the database containing the token in the value of the column.

3. The method of claim 1, wherein the node is associated with a substring, the substring of the node having the same length as the substring of every node in the data structure.

4. The method of claim 3, wherein the substring occurs in the column value of one or more rows in the table.

5. The method of claim 1, wherein the data structure is a tree.

6. The method of claim 1, further comprising:
transmitting the final set of result rows to a client system.

7. A computer program product comprising a computer usable medium having computer program logic recorded thereon for enabling a processor to optimize a LIKE query on a table in a database system, the computer program logic comprising:
receiving means for enabling a processor to receive the LIKE query, the query requesting a set of result rows wherein values of a column of the result rows matches a search string;
traversing means for enabling a processor to traverse a data structure to locate a node representing a token of the search string;
accessing means for enabling a processor to access a bitmap associated with the node;
determining means for enabling a processor to determine a preliminary set of result rows responsive to the query, the preliminary set of result rows based on the bitmap; and
removing means for enabling a processor to remove result rows from the preliminary set of result rows to generate a final set of result rows based on knowledge of the position of the search string within the value of the column associated with a result row being removed.

8. The computer program logic of claim 7, wherein the bitmap represents all rows of the table in the database containing the token in the value of the column.

9. The computer program logic of claim 7, wherein the node is associated with a substring, the substring of the node having the same length as the substring of every node in the data structure.

10. The computer program logic of claim 9, wherein the substring occurs in the column value of one or more rows in the table.

11. The computer program logic of claim 7, wherein the data structure is a tree.

12. The computer program logic of claim 7, further comprising:
transmitting means for enabling a processor to transmit the final set of result rows to a client system.

13. A system capable of optimizing a LIKE query on a table in a database system, comprising:
a first module to receive the LIKE query, the query requesting a set of result rows wherein values of a column of the result rows matches a search string;
a second module to traverse a data structure to locate a node representing a token of the search string;
a third module to access a bitmap associated with the node;
a fourth module to determine a preliminary set of result rows responsive to the query, the preliminary set of result rows based on the bitmap; and
a fifth module to remove result rows from the preliminary set of result rows to generate a final set of result rows based on knowledge of the position of the search string within the value of the column associated with a result row being removed.

14. The system of claim 13, wherein the bitmap represents all rows of the table in the database containing the token in the value of the column.

15. The system of claim 13, wherein the node is associated with a substring, the substring of the node having the same length as the substring of every node in the data structure.

16. The system of claim 15, wherein the substring occurs in the column value of one or more rows in the table.

17. The system of claim 13, wherein the data structure is a tree.

18. The system of claim 13, further comprising:
a sixth module to transmit the final set of result rows to a client system.
